(19) United States
(12) Patent Application Publication
(10) Pub. No.: US 2006/0031058 A1
(43) Pub. Date: Feb. 9, 2006

(54) Virtual model generation via physical components

(76) Inventor: Gregory Roberts Roelofs, San Jose, CA (US)

Correspondence Address: PHILIPS INTELLECTUAL PROPERTY & STANDARDS, P.O. BOX 3001, BRIARCLIFF MANOR, NY, 10510, US

(21) Appl. No.: 11/246,578

(22) Filed: Oct. 7, 2005

Related U.S. Application Data
(62) Division of application No. 09/777,504, filed on Feb. 5, 2001.

(51) Int. Cl. G06F 9/45

(52) U.S. Cl. 703/22

(57) ABSTRACT

A system for creating a virtual model of a physical structure in accordance with the present invention comprises a baseboard; at least one sensor providing sensor data; at least one building component capable of being sensed by the sensor and mountable on the baseboard; a computer interfaced with and receiving data from the sensor, for determining the position and dimensions of each component mounted on the baseboard based on the sensor data; and wherein the computer creates a virtual model to be displayed on a computer display of a structure composed of each of the components mounted on the baseboard based on the position and dimensions of each of the components. The building components comprise electrical contact points having electrical signatures. The sensor is a circuit board connected to a power source and comprises a voltmeter, an ammeter, a switching network and a processor receiving data from the voltmeter and for controlling the voltmeter, ammeter and the switching network. The sensor senses the electrical signature, location and orientation on the circuit board of each building component.

### BACKGROUND OF THE INVENTION

1. Field of the Invention

This invention relates to a system and method for creating a virtual model, and in particular, to a system and method of transforming a 3-D physical model formed of physical manipulable components, and translating the physical model into a virtual model.

2. Description of Related Art

A small-scale model is often useful for designing or analyzing a full sized structure such as a building. Examples of models include a 3-dimensional model (such as a structure), a 2-dimensional model (such as a diagram) and a virtual model.

A virtual model is a computer display on a 2-dimensional surface of a 3-dimensional physical entity, wherein the image appears to be 3-dimensional. A virtual model can be created to model an actual or an imaginary 3-dimensional entity, which may be a man-made or natural entity. Virtual models are used for research, entertainment, and commercial as well as educational applications.

It is possible to apply software to the virtual model for many purposes such as for analyzing the physical entity, manipulating and modifying the virtual model, analyzing the modified version and creating imaginary entities. For cases in which the entity is man-made, the virtual model can be used to produce blue prints for the actual construction of the entity.

Computer programs exist, at various levels of sophistication, for providing the means to create virtual images. Typically a menu of 3-dimensional components is provided as well as tools for manipulation of the components such as mice, tablets and space balls. The user combines the components in spatial relationships by selecting components and their placement. Highly sophisticated computer drafting tools, such as Computer Aided Design (CAD), are used by trained professionals, such as engineers. Less technically oriented computer modeling tools, for example virtual reality building tools, such as Active Worlds, Cosmo Worlds, VRCreator, Internet3D Space Builder, V-Realm builder, etc., are available to the layman; however, even these require spatial recognition, the ability to understand and manipulate the virtual model and a level of comfort with the use of computers.

A disadvantage to current computer virtual model tools is the limitation of choices available for the selection and manipulation of the virtual components. Furthermore, a gap exists between reality and virtual models. It is difficult to produce a virtual model that models accurately a concept in a designer's mind. This may lead to the designer of a virtual model being dissatisfied with a physical rendition of the virtual model built according to blueprints produced from the virtual model.

Head-mounted displays, data gloves and other body sensors may also be used to manipulate virtual objects, optionally with tactile feedback. However, these do not provide a means for sensing the actual components of a physical structure for producing an accurate virtual model of the structure. Furthermore, such devices are very expensive.

3D laser scanners, used for virtual 3-Dimensional reproductions of physical objects, are restricted to small volumes, and are also very expensive.

Problems also exist relating to the creation and manipulation of a virtual image due to the lack of ability of the average human to convert between a mental image or observed physical entity and an actual 3-dimensional image. Conceptualization of spatial relationships is an aptitude that is often undeveloped or lacking in the layman. Creation of a virtual image of an existing or imaginary entity poses a challenge for persons not trained and skilled in spatial drawing and computer usage.

In contrast, from an early age, children learn and play by manipulating objects and creating structures. Adults usually have a highly developed ability to build and modify a structure according to a mental image or an observed physical entity. Average people, including children, are able to create a miniature physical model of a full sized structure when provided with the proper tools.

However, although it is far easier for the average person to create a physical model of a full sized structure than a virtual model, the virtual model provides many benefits, which a physical model cannot.

A system for creating a virtual model based on a structure built from a construction toy is disclosed by Mitsubishi Electric Research Laboratory (MERL) in an article entitled “Tangible Interaction+Graphical Interpretation: A New Apporach to 3D Modeling” by David Anderson et al., (April, 2000) (published in the Proceedings of SIGGRAPH 2000, Jul. 23-28, 2000 (New Orleans, La.) and also found at www.merl.com/reports/R2000-13/index.html). However, the MERL system is complicated and expensive to produce.

Accordingly, there exists a need for a simple and inexpensive system for converting a physical model into a virtual model.

### SUMMARY OF THE INVENTION

Therefore, it is an object of the present invention to provide an easy to use and understand system and a method for facilitating the creation of a realistic virtual model of a physical entity.

It is a further object of the present invention to provide a system and a method for creating a physical model of a physical entity and translating it into a virtual model.

It is a further object of the present invention to provide a system and a method for sensing and identifying the components of a physical structure, for sensing the location and orientation of the physical components in relation to a reference, and creating a virtual model of the physical structure based on the component's identity and its relative position of placement.

To achieve the above objects, a system for creating a virtual model of a physical structure in accordance with the present invention comprises a baseboard; at least one sensor providing sensor data; at least one building component capable of being sensed by the sensor and mountable on the baseboard; and a computer interfaced with and receiving data from the sensor, for determining the position and dimensions of each component mounted on the baseboard based on the sensor data; means wherein the computer creates a virtual model to be displayed on a display means where the virtual model is a model of a structure composed of each of the components mounted on the baseboard based on the position and dimensions of each of the components.

The building components comprise electrical contact points having electrical signatures. The sensor is preferably a circuit board connected to a power source and comprises a voltmeter, an ammeter, a switching network and a processor receiving data from the voltmeter and for controlling the voltmeter, ammeter and the switching network. The sensor senses the electrical signature, location and orientation on the circuit board of each building component.

The present invention also includes a method for creating a virtual model, to be displayed on a computer display, of a physical structure comprising the steps of sensing each component mounted on a baseboard; determining the position and dimensions of each component mounted on the baseboard based on the sensed data; creating a virtual model of a structure composed of each of the components mounted on the baseboard based on the determined position and dimensions of each component.

The method first senses the components by scanning an electrical circuit board formed on the top layer of the baseboard. The circuit board is scanned by successively testing each of an array of contact points having predetermined positions on the circuit board by applying voltages to each contact point and sensing voltage and current levels of proximate contact points. The voltage and current data provide the data used to determine the location, orientation and identity of each component. The identity is used to determine properties comprising the shape and dimension of each component.

### BRIEF DESCRIPTION OF THE DRAWINGS

The above and other objects, features and advantages of the present invention will become more apparent in light of the following detailed description of an exemplary embodiment thereof taken in conjunction with the attached drawings in which:

FIG. 1 is a block diagram of the system in accordance with the present invention;

FIG. 2 is a partially exploded perspective view of a first embodiment of the baseboard of the system in accordance with the present invention;

FIG. 3 is a circuit diagram of the conductors in a building component of the system in accordance with the first embodiment of the present invention;

FIG. 4 is a detailed diagram of a portion of the circuit board of the system, in accordance with the first embodiment of the present invention;

FIG. 5 is a circuit diagram of the components of the sensor of the system, in accordance with the first embodiment of the present invention;

FIG. 6 is a flowchart of the steps performed while scanning the circuit board of the system, in accordance with the first embodiment of the present invention; and

FIG. 7 is a perspective view of a second embodiment of the baseboard of the system in accordance with the present invention.

### DETAILED DESCRIPTION OF THE PREFERRED EMBODIMENT

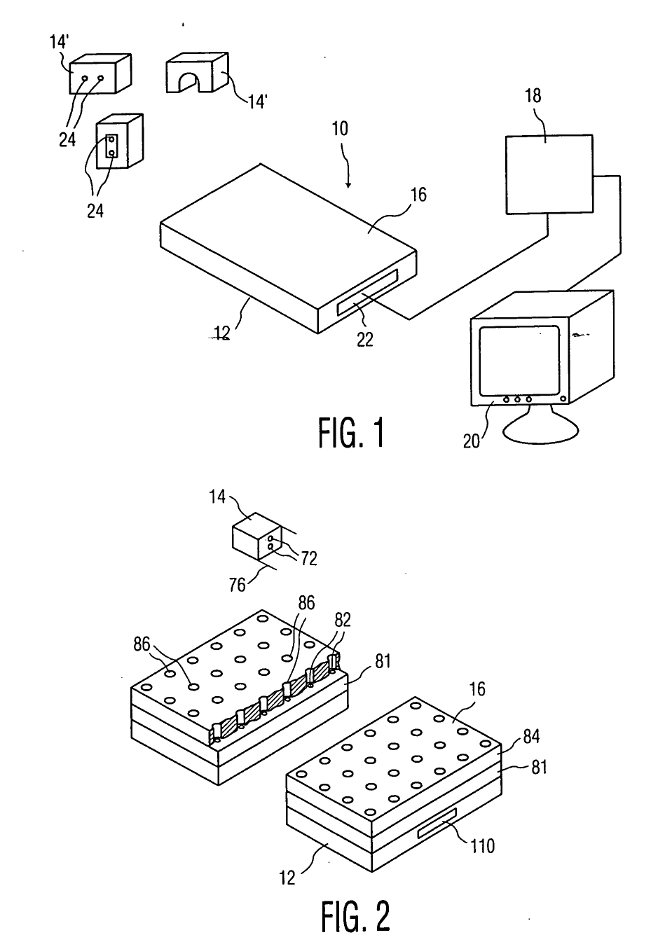

Turning now to the drawings, in which like reference numbers identify similar or identical elements throughout the several views, in particular with reference to FIG. 1, the system, shown at 10, comprises a baseboard 12, building components 14 for mounting upon the baseboard 12, at least one sensor 16 for sensing each component 14 mounted on the baseboard 12. The sensor 16 provides sensor data to a computer 18. The computer 18 converts the sensor data into display data for providing a virtual image of a structure formed by the building components 14. A display means such as monitor 20 receives display data from the computer 18 and displays the display data.

The baseboard 12 provides a surface upon which the building components 14 are mounted. In the preferred embodiment the baseboard provides a plane of reference for the positioning of the building components. Furthermore, in the preferred embodiment, the baseboard 12 houses the sensor 16 and an interface 22 for interfacing between the sensor 16 and the computer 18.

Each building component is constructed of a material that is capable of being sensed by the sensor. Each building component is further provided with an identification means 24 capable of being sensed by the sensor. The identification means is preferably in the form of a label, which identifies the building component for purposes of identifying properties of the component such as the component's dimensions. The identification label can be a barcode, a color, a code produced by a microchip or any identifying feature. Building components that are capable of being placed in different orientations are constructed to provide the identification label to the sensor from the appropriate surface.

It is to be understood that the sensor can be comprised of separate components, which together provide the function of the sensor. The function of the sensor is to determine the position in space of each building component according to its dimensions. In the preferred embodiment this is accomplished by detecting the presence of each building component, detecting the position, including the orientation, of the building component and identifying the building component. Some examples of sensors include a camera, a sound detector, a thermal detector, an electrical circuit sensing the presence of an electrical stimuli, etc.

The interface 22 facilitates communication between the sensor 16 and the computer 18. The interface 22, for example, includes a port such as an RS-232 or USB port for facilitating a cable connection. The interface 22 may also be wireless, and include an interface for receiving optical waves, radio waves, infrared waves, etc. In other embodiments the interface 22 is means for connecting to a network, intranet or the Internet. It is also contemplated that the interface 22 can be a separate unit from the baseboard. The computer 18 is any computing device, from a single microprocessor or micro controller to a computer system distributed over multiple processing nodes. The term “compute” is used in the most general sense. In one embodiment the computer 18 is connected to the Internet and accessed by the sensor via the Internet. In another embodiment the computer 18 comprises a first computer interfaced to the sensor and a second computer in communication with the first computer via a network such as the Internet wherein the functions of computer 18 reside in the first and second computer.

The computer 18, running a software application, processes the sensor data and transforms it into a virtual image of the structure formed by the building components 14. In the preferred embodiment, the sensor data provides sufficient data such that the computer 18 can determine the identification and location of each building component 14. The computer 18 determines the properties and dimensions of the building component 14 according to the identification of the building component 14. The computer 18 combines the dimension information with the position information to provide display data for displaying a 3-dimensional image of the building component 14. The computer 18 combines the display data for each component to form a virtual image of the structure formed by the building components 14.

The software application and the functions of the computer 18 can be distributed amongst a processor associated with the sensor and the computer 18. Furthermore, the software application and the functions of the computer 18 can be distributed between a local server and a remote server, for example a web server providing Internet service.

A first embodiment of the present invention is shown in FIG. 2. Each of the building components 14 is formed of a nonconductive material and further comprises at least one electrical contact point such as a projecting pin 72, formed of a conductive material. The identification label 24 is an electronic signature sensed upon making electronic contact with the projecting pin 72. In the preferred version the electronic signature is provided by passive electronic components associated with each pin 72, such as at least one resistor providing a predetermined amount of resistance.

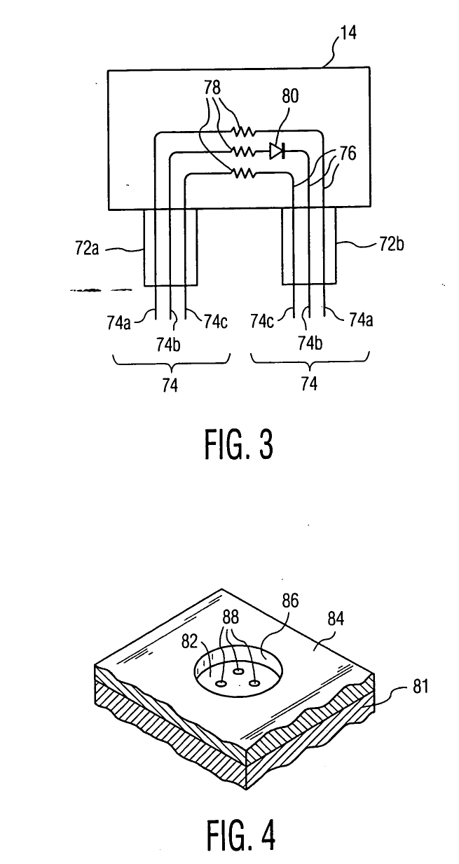

In a preferred embodiment, as shown in FIG. 3, each building component is provided with two associated conductive pins 72a, 72b. Each pin 72a, 72b is provided with at least one independent conductor, and preferably three conductors 74a, 74b, 74c, each conductor 74 being independently addressable. Each conductor 74 is in mutual paired correspondence with another conductor 74 in its associated pin. As shown, conductors 74a, 74b, 74c of pin 72a correspond with conductors 74a, 74b, 74c of pin 72b, respectively. A conductive connection 76, including a resistor 78, is a made between each pair of corresponding conductors. Each resistor 78 has a resistance selected from a group of resistance values. In the preferred embodiment the group of resistance values consists of 6-9 different resistance values such as 1k, 2k, 5k, 10k, 20k, 50k, 100k, 200k, and 500k ohms. The combination of resistors 78 selected for the conductive connections 76 in each structural component 14 provides the identification label 24 of the structural component 14, readable upon applying a voltage across the connections 76 and measuring the currents flowing. A diode 80 is provided for one of the conductive connections between one of the corresponding conductor pairs. The diode 80 allows current to flow through the connection in only one direction.

In the preferred version, referring back to FIG. 2, associated pins 72a, 72b of a building component are located proximate one another, and additional nonconductive pins 77 are provided as per design, for structural support of the building component 14 on the baseboard 12.

In another embodiment, a building component having a small base is provided with one pin 72, the pin 72 having two sets of corresponding conductors 74. In another embodiment, the building components 14 are provided with greater than two pins. In yet another embodiment each pin 72 is provided with one conductor pair 74 having an identifying resistance associated with it, the resistance formed of a unique combination of resistors in series, the resistors being selected from a group of known resistance values.

Referring to FIG. 2, the sensor 16 of the first embodiment will be discussed. The sensor 16 senses the presence and position of each building component 14 on the top surface of the baseboard 12. The sensor 16 further reads the identification label 24 for each building component 14. The sensor 16 is comprised of a circuit board 81 providing an array of electronic contacts 82 at predetermined locations. In the preferred embodiment the sensor is the circuit board 81, formed on the top surface of the baseboard 12, covered by a nonconductive covering 84 having an array of holes 86 placed at a predetermined pitch, exposing the array of electronic contact points 82 on the circuit board 81. As shown in FIG. 4, a conductor 88 is provided at each contact point 82 for making contact with each conductor 74 of the pin 72 to be inserted in the hole 86. In the preferred embodiment, each contact point 82 has three conductors 88. The sensor scans the circuit board 81 for mounted building components 14.

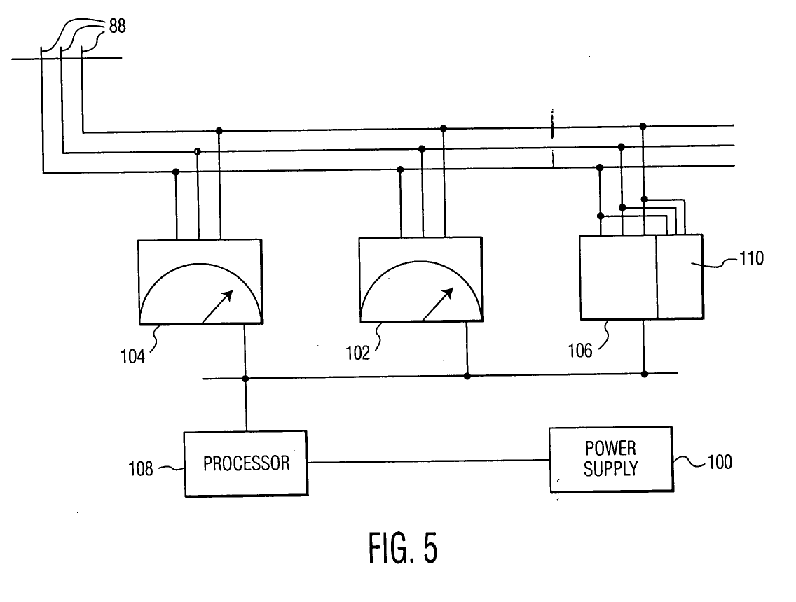

FIG. 5 shows the preferred embodiment of a means for scanning associated with the sensor comprising: a means for applying voltage, such as a power source 100, for applying voltage to a selected contact point 82; a voltmeter 102 for measuring voltage at a selected contact point 82; an ammeter 104 for determining the current at a selected contact point 82; a switching network 106 for selecting contact points 82; and an embedded processor 108 for controlling the voltmeter 102, ammeter 104 and switching network 106 and receiving data from the voltmeter. The processor 108 is any processing device capable of receiving data from and controlling electronic devices. Interface 110 interfaces the processor 108 to the baseboard interface 22 for interfacing to the computer 18. The processing and functions performed by the processor 108 associated with the sensor 12 and the computer 18 can be distributed between the processor 108 and the computer 18.

In use, a user mounts building components 14 on the baseboard 12 by inserting each of its pins 72 in one of the holes 86 so that the pins 72 contact the circuit board 81. When the user is ready to request that the physical model be transformed into a virtual model, the user activates the interface between the sensor 16 and the computer 18. In the preferred embodiment, the interface means is housed within the baseboard 12, and a cable is coupled at one end to interface 22 in the baseboard 12, and at the other end to the computer 18. The user runs a program on the computer for accepting the sensor data and converting it into virtual image data. The user initiates the process of transferring data from the sensor 16 to the computer 18 by making a selection via the computer 18 or a switch on the baseboard 12 coupled to the sensor 16. In the preferred embodiment, the user initiates the process via a user interface associated with the computer 18, and the computer instructs the sensor to begin scanning the circuit board 81.

Control of the scanning process and storage of the sensor data is provided by the processor 108 of the sensor 16 or the computer, or a combination of the two.

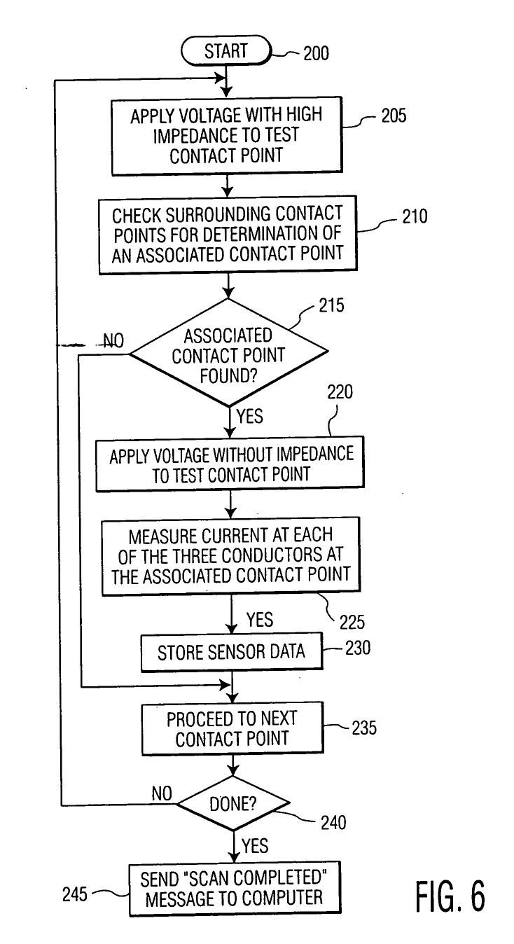

The scanning process is shown in FIG. 6. The process starts at step 200 in which the first contact point 82 is selected as the test contact point. At step 205 a voltage is applied to the test contact point. It is only necessary to apply voltage to one selected conductor of the conductors without a connected diode, such as 74a or 74c. The voltage is applied with a high impedance, such as a transistor or an op-amp 110, so that the internal resistance in a structural component 14, which might be mounted there, is irrelevant. At step 210 a conductor corresponding to the selected conductor of the contact points 82 surrounding the test contact point are tested by the voltmeter to find a contact point which has a positive voltage, indicating that it is associated with the same structural component 14 as the test contact point. The size of the area surrounding the test contact point which is scanned for an associated contact point includes all contact points within a radius determined by the largest possible distance between associated pins of any structural component 14. At step 215 it is determined if an associated contact point was found. If not, control goes to step 235. If found, control goes to step 220. At step 220 a voltage is applied, without the high impedance, to each conductor, one at a time, of the test contact point. At step 225 the current is measured at each corresponding conductor of the associated contact point. At decision step 227 a determination is made if the final conductor has been tested yet. If not, control returns to step 220. Once all of the conductors have been tested control goes to step 230. At step 230 the sensor data, comprising the measured current values from step 225 together with the positions of the test contact point and the associated contact point, are stored. At step 235 the next contact point 82 on the circuit board 80 is selected. Each contact point 82 is selected once as a test contact point. At step 240 a determination is made if there are no more contact points 82 to be scanned, indicating that the scan is completed. If the scan is completed, a message or signal is transmitted to the computer 16. If the scan is not yet completed, control returns to step 205.

The sensor data is stored by the sensor 16 until the scanning process is completed. Upon completion, the stored sensor data is transmitted to the computer 18. Alternatively, the stored data is transmitted as it is produced, and stored by the computer 18.

For each pair of associated contact points two sets of data are stored. The current measured and stored in the first set of data of an associated pair of contact points for the current which passes through the associated conductive connection 76 that includes a diode is 0 amps. The current measured and stored in the second set of data for the same associated conductive connections with current flowing in the opposite direction is non-zero and is indicative of the resistance of the resistor 78 provided for the associated conductive connection 76. The use of the terms first and second is not indicative of the order in which they were measured. The second set of sensor data provides the data necessary for calculating the total resistance of the three associated conductive connections 76, which is the identification label 24 of the building component. The orientation of the building component is determined by zero current of the first set of data. Thus, the orientation together with the stored location of the associated pins and the identification label of the building component provides the necessary information for producing a visual image of the building component.

In another embodiment the identification label of each building component is determined prior to mounting it on the baseboard. For example, a building component identity code can be entered via a user interface such as a keyboard or a bar-code reader. Alternatively, intelligent recognition methods are used for identifying each building component 14. The position of the building component can be manually entered as well via a user interface.

When the scan is complete, the sensor data includes a value of the current measured for each set of associated contact points 82 on the sensor having contact with conductive pins 88 of each building component mounted. The computer 18 receives and processes the sensor data to determine the location and orientation of each set of associated contact points 82 as well as the identity of each building component 14. The computer 16 consults a database of profiles for building components and retrieves the properties of each building component identified. The properties include the shape and dimensions of the building component 14. From the properties retrieved the computer can produce a virtual image of each building component at a location corresponding to the actual position of the building component on the baseboard.

In the preferred embodiment the user has the option to continue building successive levels of building components that will be combined into a virtual display of a single multi-level structure. Each level is built separately on a baseboard 12. It is possible to use one baseboard 12 for multiple layers by disassembling each layer after it is scanned and proceeding to build a new layer. The user specifies to the computer at which level the new layer should be incorporated into the virtual model. In the preferred version the user can instruct the computer to include a layer multiple times in the virtual model.

In the preferred embodiment, the formation of the virtual image is performed upon completion of a structure, upon which the interface within the baseboard is connected to the computer. However, it is further possible to interface the baseboard to the computer while the building components are being mounted, and for the computer to provide an ongoing display of the structure as it is being built.

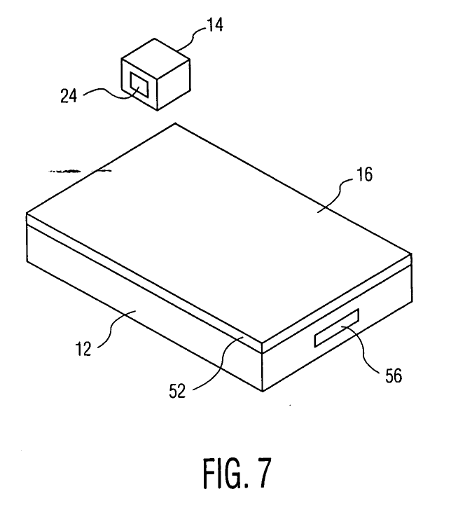

Referring now to a second embodiment shown in FIG. 7, the identification label of each building component 14 a magnetic signature, each label being accessible from a surface that is to be sensed by the sensor.

The sensor 16 comprises a magnetic sensing board 52 forming the top surface of the baseboard 12. The board 52 of the sensor 16 is capable of reading a magnetic signature identification label 24 of each building component 14 mounted on the baseboard 12, as well as sensing the location and orientation of the building component 14 on the board 52. Interface 56 is provided for communicating with computer 18.

In another embodiment, the building components 14 are formed of a conductive polymer and are placed directly on a sensor capable of sensing a conductive material such as a circuit board.

The 3-dimensional shape of each building component 14 is either sensed by the sensor, or stored in association with the building component's 14 identification by the sensor or the computer.

In another embodiment each of the building components 14 and/or the sensor comprise embedded microchips. Embedded chips in the building components 14 store the identification code. Alternatively the properties associated with the building components 14 are stored in the embedded chips in the building component 14 itself, or alternatively in the sensor 16.

In another embodiment, each building component includes sensor for sensing for sensing building components stacked directly on top of it. Furthermore, each building components includes an embedded chip for querying the building component stacked directly above it about its identity and what is stacked above it. Each building component stores sensor data relative to all of the building components stacked above it. The bottom layer of building components supplies all of the sensor data to the sensor housed in the baseboard. The baseboard produces its own sensor data and transmits its own sensor data plus the sensor data supplied by the bottom layer to the computer.

In another embodiment, building components include sensor for sensing neighboring building components, storing the sensor data and providing the sensor data to the computer 18.

It is contemplated that the building components 14 are actual components, such as bricks, beams and panels, to a full sized structure. Virtual modeling of an actual structure provides the means to analyze the structure by using computer processing tools. The computer 18 analyzes the existing structure according to the properties of its components, environmental factors, the actual condition of the structure and users' present/future needs. Thus, the invention is a tool for making determinations relating to events such as a predicted earthquake, flood, hurricane; planning of renovations for future needs; assessment of damage due to aging or disasters; and analysis of structures relative to predicted warfare.

It is also contemplated that various structures can be modeled via the building components mounted on the baseboard. For example, the baseboard could be a mannequin and the building components could be articles of dress; the baseboard could be any reference point or surface and the structure could be a transportation vehicle or a mechanical device. The structure is transformed into a virtual model according to the properties of the building components. It is also possible for the virtual model to simulate motion of the components of the structure while incorporating the properties thereof

While the invention has been shown and described with reference to certain preferred embodiments thereof it will be understood by those skilled in the art that various changes in form and detail may be made therein without departing from the spirit and scope of the invention as defined by the appended claims.

1-13. (canceled)

14. A component formed of a nonconductive material, for mounting on a baseboard comprising:
a pair of associated electrical contact points; each contact point having a plurality of conductors; each conductor independently connected in one to one correspondence to an associated conductor in the associated contact point with each connection including a resistor selected from a predetermined group of possible resistors; and
wherein an electronic signature for identifying the component is comprised of a combination of the resistors of the plurality of the connections of the associated conductors of the component.

15. The component of claim 14, wherein one of the connections further includes a diode.

16. A software application receiving sensor data for at least one component mounted on a baseboard, comprising computer program code;
wherein the sensor data comprises data representative of an identity, orientation and a location on the baseboard for each component mounted on the baseboard;
wherein the computer code processes the sensor data for determining the identity, position and orientation of each component mounted on the baseboard;
wherein the computer code accesses property data including data representative of the dimensions and shape of each component available for mounting, for determining the dimensions and shape of each component mounted on the baseboard in accordance with the identity of each component;
the computer code creating a virtual image representative of an arrangement of the components mounted on the baseboard based on the shape, dimensions, orientation and location of each component mounted on the baseboard.

17. The software application according to claim 16,
wherein the baseboard comprises a circuit board;
wherein the sensor data comprises data indicative of current values and associated resistance associated with each contact point of a grid of contact points on the circuit board;
wherein the identity is determined according to the resistance associated with each component mounted on the circuit board.

18. A sensor for sensing the identity, location and orientation of components mounted on a baseboard comprising;
a circuit board, mounted on the baseboard, having a grid of contact points, each contact point having a plurality of conductors;
wherein the sensor is connected to a power source and accesses a voltmeter, an ammeter and a switching network; and
wherein the sensor further accesses a processor for receiving data from the voltmeter and for controlling the voltmeter, ammeter and the switching network.

19. A method for creating a virtual model, to be displayed on a computer driven display, representative of at least one component mounted on a baseboard, wherein each component mounted on the baseboard makes electrical contact with an electrical circuit board formed on the baseboard and wherein the circuit board has an array of contact points, each contact point having a predetermined location on the circuit board; comprising the steps of:
successively applying a high impedance voltage to each contact point for testing each contact point of the array of contact points, for determining the presence and location of a mounted component in electrical contact with the contact point being tested;
measuring the voltage for contact points on the circuit board within a predetermined radius of the contact point being tested;
determining that a component is in electrical contact with the test contact point and an associated contact point having a nonzero measured voltage, at the locations of the contact point being tested and the associated contact point, wherein the location of the contact point being tested and the associated contact point is location data for the component determined to be in electrical contact;
applying a low impedance voltage to the contact point being tested when determined to be in electrical contact with a mounted component;
sensing the current values for the contact point being tested and its associated contact point indicative of an identification of the component determined to be in contact with the contact point being tested and its associated contact point, wherein the identification of the component is identification data;
consulting a database of component identifications storing property data comprising dimension data for each component identification; and
creating a virtual model representative of an arrangement of the components when mounted on the baseboard according to a structure composed of each of the components based on the location data, identification data and property data for each component.

20. The method according to claim 19, wherein a level of components is mounted on a baseboard, and wherein a virtual image having successive levels is formed by the steps of:
creating a virtual model of a first level;
creating a physical structure for a second level;
creating a virtual model of the second level and integrating it into the virtual model of the first level.
